(19) United States
(12) Patent Application Publication
(10) Pub. No.: US 2006/0038113 A1
(43) Pub. Date: Feb. 23, 2006

(54) Photodetector arrangement and method for stray ligh compensation

(76) Inventors: Helmut Riedel, Fuerstefeldbruck (DE); Andreas Von Dahl, Ingolstadt (DE); Christian Lang, Laufen (DE); Friedrich Zywitza, Ingolstadt (DE)

Correspondence Address: FASSE PATENT ATTORNEYS, P.A., P.O. BOX 726, HAMPDEN, ME, 04444-0726, US

(21) Appl. No.: 10/527,396

(22) PCT Filed: Aug. 22, 2003
(86) PCT No.: PCT/DE03/02813

§ 371 Date: Mar. 11, 2005

(30) Foreign Application Priority Data
Sep. 13, 2002 (DE) 102 42 690.2
Jan. 21, 2003 (DE) 103 02 402.6

(51) Int. Cl. H01J 40/14; G01J 1/44

(52) U.S. Cl. 250/214 C; 250/214 R

(57) ABSTRACT

The invention relates to a photodetector arrangement for stray light compensation with a photodetector unit for detecting and determining at least two measuring signals and with a differential unit for subtraction of the measuring signals, wherein between the photodetector unit and the differential unit a compensation unit is provided for compensating the constant components forming the basis of the respective measuring signal.

The invention relates to photodetector arrangement and a method for stray light compensation, in particular in case of differential signal analyzing methods.

In optical measurement scenes are often actively illuminated. The information for producing the set are usually generated in an element for image recording, i.e. the film camera. Type and form of the signals produced by the film camera highly depend on the applied measuring principle and of its mode of implementation.

With methods that provide images, which make use of the difference of two or more signals, subject to the respective measurement and functional principle, resp., it comes to non-useful constant components, when generating the signals, which components limit the dynamic range available. Moreover, by an existing stray light (background light of the sun, other light sources such as floodlight, fluorescent lamps, etc.) a constant component is added to the active illumination (e.g. infrared light, modulated or non-modulated light). In this connection the intensity of the active illumination may be below the intensity of the stray light. In such cases the detector signal is dominated by the stray light and the desired wanted signal from the active illumination takes only a minor fraction of the total signal.

In particular differential signal analyzing methods, which use photodetectors for distance measurements according to the phase correlation method, are limited in their efficiency by the constant elements of the signals entering the subtraction. Examples from automotive engineering for this are 3D distance cameras with photonic mixer detectors (Photonic Mixer Devices, also called in short PMD)

In fact, this formulation of the problem can usually be somewhat mitigated by using photodetectors with an extremely large dynamic range, however, with such detectors the question of sufficiently good signal/noise ratio persists. Also with sensors with a large dynamic range the limitations of the dynamic range excited by the constant components are considerable in case of differential signal analyzing methods.

At present, several concepts for high-dynamic photodetectors are described in literature: The concepts described there use components with logarithmic characteristics for signal compression (Hoefflinger et al., IMS-Chips, Institute for microelectronic systems, Stuttgart) or control the integration time adapted to the illumination intensity appearing at the detector (M. Boehm et al., “High Dynamic Range Image Sensors in Thin Film on ASIC Technology for Automotive Applications”, Advanced Microsystems for Automotive Applications, Springer-publishing house, Berlin, pp. 157-172, 1998). More detailed information can be found under the internet addresses of IMS-Chips (www.ims-chips.de) and Silicon Vision (www.siliconvision.de).

A separation of photo signals, which resulted from an interaction of active illumination and stray light, can be achieved for arrangements and methods according to the state of art only via chronological successive measurements.

In doing so in a first measurement the photo signal is detected by the cumulative effect of stray light and active illumination. In a subsequent second measurement the photo signal of the stray light is detected with the active illumination being switched-off. The sequence of the measurements can also be changed. Subsequently, the wanted signal can be determined by subtracting the stray light signal from the total signal.

Starting from here it is the object of the present invention to indicate a photodetector arrangement for stray light compensation and a method for operating such photodetector arrangement, which allow for a particularly high suppression and compensation, resp. of the photo signal portion excited by the stray light.

The first object is attained in accordance with the invention by a photodetector arrangement for stray light compensation with a photodetector unit for detecting and determining at least two measuring signals and with a differential unit for subtraction of the measuring signals, wherein between the photodetector unit and the differential unit a compensation unit is provided for compensating the constant components forming the basis of the respective measuring signal.

In this context the invention acts on the thought that for enhancing the efficiency of a photodetector arrangement a part as large as possible of the dynamic range of a related photodetector unit can be used for detecting and determining the portion of the measuring and wanted signals that form the difference. Therefore, the measuring and wanted signals should be reduced by those signal portions, which have not been caused by stray signals. For a compensation as high as possible of spurious components in the measuring signal in case of a difference analyzing method performed with the aid of several measuring signals, the measuring signals should be detected and determined in differentiated manner. In particular, for each individual measuring signal a possibility should be found, by means of which the spurious components, produced in particular by constant components, of the received measuring signals can be suppressed or minimized. For this purpose a compensation unit is provided directly after the photodetector unit for suppressing or compensating, resp., the constant component excited by the stray light in the respective measuring or wanted signal. By means of this it is ensured that a suppression or compensation, resp., of the constant components, caused by the measuring principle, of the measuring or photo signal is effected within only one measurement directly in the photosensitive component.

For a signal-related compensation of the constant components representing the spurious components the compensation unit comprises a number of differential modules which corresponds to the number of the measuring signals. Multiple measurements are certainly avoided by such processing directly after the detection, which processing depends on the signal and moreover on the constant component of the multiple measuring or photodetector signals forming the basis of the differential signal analyzing method.

Advantageously, the compensation unit comprises an amplifier unit. In a particularly simple manner an extraction of the signal portion is possible By means of this it is possible to extract the signal portion that can be used for subtraction of the spurious component and above all to extend the dynamic range of the photodetector unit when detecting the measuring signals with a high interference and background level, resp., and with a low portion of wanted signals. Depending on type and design of the amplifier unit a static or variable amplification factor k can be adjusted or predetermined. In an preferred form of embodiment an amplifier unit common for all measuring signals is provided. Alternatively or additionally, divers amplifier units can be provided. For instance, a number of amplifier units is provided which corresponds to the number of the detected measuring signals.

For ensuring a constant component compensation also in case of unknown, changing measuring or wanted signals, the compensation unit comprises advantageously a limit value module, in particular for detecting the minimum or maximum value of the applied measuring or wanted signals. Depending on type and adjustment of the limit value module the degree of compensation can be adjusted accordingly.

In particular, the photodetector unit is embodied as a photonic mixer detector (also called in short PMD). The photodetector arrangement comprising the photodetector unit, the compensation unit and the differential unit can be implemented in a particularly simple form of embodiment with low installation space as an integrated circuit, in particular with integrated electronic components. Preferably, the photodetector unit is embodied as an active pixel sensor (also called in short “Active Pixel Sensors (APS), the dynamic range of which, for instance, can be used to the largest extent for the detection of the “difference forming portion” of an active scene illumination.

The second object is attained according to the invention with a method for stray light compensation of measuring signals detected by means of a photodetector unit, wherein a constant component forming the basis of the respective measuring signal is compensated before subtraction of the measuring signals.

Advantageous further embodiments of the invention are part of the subclaims. The method can be implemented directly in a photodetector arrangement with the aid of integrated electronic components, so that photodetectors with the described properties can be embodied as Active Pixel Sensors (APS) and can be realized in simple manner e.g. in the CMOS-technology. It is also essential that the method is not restricted to photodetectors, but can principally be applied to all signals, which are composed of spurious components and wanted signal.

The advantages obtained by means of the present invention are in particular that the compensation of the portion of spurious components, integrated directly within the photodetector arrangement, linearizes the transfer characteristics and reduces the influence of disturbances acting largely in the same direction before subtraction of the two output signals compensated by the portions of spurious components. In other words: By direct compensation of the portions of spurious components, such as e.g. stray light, of the photodetector signals detected and provided for subtraction, the ensuing subtraction is largely unaffected. By means of this the directly detected photodetector signals are divided or separated into a disturbing portion of light to be compensated and in a portion of light useful for subtraction. This leads to an increase of the useable dynamic range of the photodetector arrangement. By the direct processing of the measuring signals while taking into account the compensation of constant components caused by disturbances, a photodetector arrangement of this type is suitable for a real time signal reception and thus for a particularly fast, analogue signal processing, for example a photodetector arrangement of this type comprises a so-called high frame rate and short measuring times in image recording systems.

Beyond that, the photodetector arrangement is suitable for single detectors as well as for line and array arrangements, e.g. for photonic mixer detectors (in short called PMD's). Further, a complex A/D conversion with ensuing value storage and subtraction can be avoided.

Advantageous and further embodiments of the invention idea will become apparent from the further description taken in conjunction with the drawing.

Hereinafter the invention is further explained by the examples of embodiment taken in conjunction with the drawings.

FIG: 1 shows a generalized schematic diagram of a photodetector arrangement for a differential signal generating method with integrated compensation unit;

FIG: 2 shows a general schematic diagram of a photodetector arrangement with an integrated amplifier unit;

FIG: 3 shows a general schematic diagram of the constant component compensation circuit for ensuring the maximum degree of compensation;

FIG: 4 shows a schematic diagram of the photodetector arrangement for constant component compensation, which is characterized by a low implementing expenditure;

FIG: 5 shows a time diagram for activating the photodetector arrangement for constant component compensation, which is characterized by a low implementing expenditure;

FIG: 6 shows a photodetector arrangement, by means of which a maximum constant component degree of compensation G_{Komp}=100% can be achieved;

FIG: 7 shows the time diagram for activating the photodetector arrangement for constant component compensation with a guarantee of the maximum degree of compensation.

Like reference numerals refer to like elements or elements with identical functions throughout all views, unless otherwise mentioned.

Before going into details with regard to the above mentioned photodetector arrangements, the basic requirements and properties of the method and of the photodetector arrangement according to the invention are preliminarily explained.

The methods for compensating constant components described in the following embodiments serve to improve applications, in which the difference is formed of at least two sizes limited in size and afflicted with constant components. The measuring signals entering subtraction are reduced for this purpose without hereby affecting the difference. To simplify matters here and in the following the case of two signals is assumed, however, the method being not limited thereto.

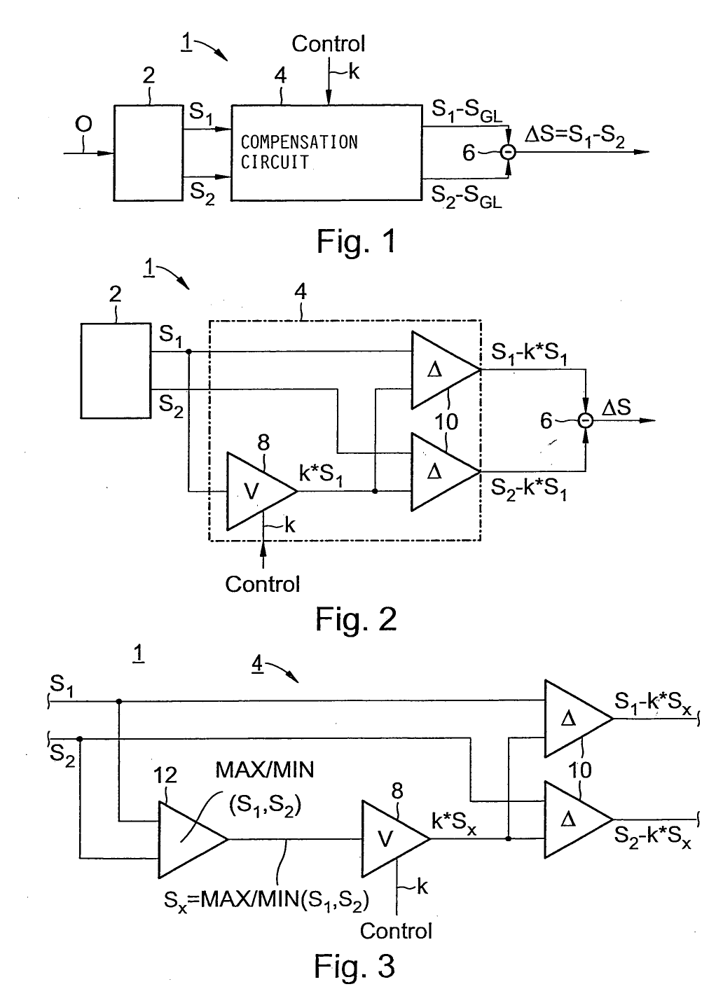

In FIG. 1 a generalized schematic diagram of a photodetector arrangement 1 for stray light compensation is shown. The photodetector arrangement 1 comprises a photodetector unit 2 for detecting and determining two measuring signals S₁ and S₂ from an optical signal O. A compensation unit 4 is arranged downstream to the photodetector unit 2 for determining a wanted signal portion S_{1Δ} and S_{2Δ}, resp., forming the basis of the respective measuring signal S₁ and S₂. By means of an amplification factor k a degree of compensation forming the basis for the compensation unit 4 is adjustable for the compensation of the disturbance portions, in particular constant components S_{GL}, forming the basis of the respective measuring signal S₁ and S₂, resp. For determining the differential signal ΔS with the aid of the respective wanted signal portions S_{1Δ} and S_{2Δ}, resp., the measuring signals S₁ and S₂ reduced by the disturbance afflicted constant components S_{GL} are supplied to a differential unit 6.

The required functional feature of the present compensation method in this case is the subtraction of two signals S₁ and S₂ afflicted, for example, with an identical constant component S_{GL} and a related wanted signal portion S_{1Δ} and S_{2Δ}, resp. Here, the following shall apply:
S₁=S_{1Δ}+S_{GL} and S₂=S_{2Δ}+S_{GL} with S_{GL}=k×Sₓ (1)
and
0≦k≦1 (2)

Here, the wanted signal portions S_{1Δ} and S_{2Δ} describe the portions of the wanted signal which exclusively contribute to subtraction. Here, the amplification factor k can optionally be fixed or adjustable. As a rule the following shall apply: Depending on the form of implementation of the compensation circuit the signal Sₓ may be S₁ or S₂, or the smaller or higher of both signals S_{MIN} or S_{MAX}.

The constant component S_{GL} can be natured as follows:
I. unknown, exclusively excited by disturbance variables;
II. caused by process and technology in fixed (=constant) relation to the measuring signals S₁ and S₂;
III. unknown, as a sum from the portions of I. and II.

The size, in particular the value of the wanted signal portions S_{1Δ} and S_{2Δ} entering directly the subtraction is predetermined by a system-specific dynamic range. The dynamic range is limited here by the interpretation of the storage capacity and/or of the circuit for signal amplification and processing, resp. For enhancing the efficiency of the differential signal forming method by enhancing the useable portion of this dynamic range the input or measuring signals S₁ and S₂ are reduced by means of the compensation unit 4 directly before subtraction by the factor k·Sₓ proportional to one of the two measuring signals S₁ and S₂.

Depending on the presetting of the proportionality factor k·Sₓ, which is formed subject to the constant component S_{GL} of the measuring signals S₁ and S₂, resp., and which may be different depending on the embodiment of the compensation unit 4, the proportionality factor k·Sₓ, however, is preferably adjusted as follows:
S_{GL}≦k·Sₓ (3)

Hereinafter, exemplarily in FIGS. 2 and 3 two more detailed forms of embodiment for the photodetector arrangement 1 are described, which differ with regard to their degree of compensation and their complexity.

For the time being for reasons of simplification the general form of the photodetector arrangement 1 according to FIG. 1 is retained and the embodiment of the compensation unit 4 is described more closely.

For the case the constant component SGL has at least one portion, which is in fixed relation to the measuring signals S₁ and S₂ (see above under item II. and III., resp.), the photodetector arrangement 1 schematically shown in FIG. 2 represents a possibility for compensating constant components which can easily be realized. The fixed or optionally adjustable amplification factor k indicates the minimum relative constant component S_{GL} of the measuring signals S₁ and S₂. Here, the signal-reducing term or proportionality factor k·Sₓ may be embodied as any function of the measuring signals S₁ and S₂, resp. In FIG. 2 the relation to the measuring signal S₁ is shown as an exemple. For producing a constant component compensation G_{Komp}, performed with the aid of the proportionality factor k·Sₓ of the respectively detected measuring signal S₁ or S₂, the compensation unit 4 comprises an amplifier unit 8 and two differential modules 10.

In general, the measuring signals S₁ and S₂ are unknown, changing signals. The degree of the constant component compensation G_{Komp} formed by the reducing proportionality factor k·Sₓ is variably adjustable by means of the amplifier unit 8. For example, the degree of the constant component compensation G_{Komp} is limited by a maximum value as per S₁>S₂ and by a minimum value as per S₁<S₂ or vice versa. In general, the following shall apply:

$${G}_{Komp} = \frac{k \cdot {S}_{x}}{{S}_{Min}} with {S}_{Min} = MIN ( {S}_{1} , {S}_{2} ) \qquad ( 4 )$$

Depending on type and design of the photodetector arrangement 1 an amplifier unit 8 common for all measuring signals S₁ and S₂ can be provided. Alternatively or additionally, several amplifier units 8, e.g. one related amplifier unit 8 per measuring signal S₁ or S₂, resp., can be provided for a signal related constant component compensation G_{Komp}.

For ensuring a maximum degree of compensation G_{Komp Max}, as is shown in FIG. 3, an additional circuit component is provided, in particular a limit value module 12, for detecting a maximum value MAX or a minimum value MIN, resp., of all input or measuring signals S₁ and S₂, applied to the limit value module 12.

The maximum constant component compensation G_{Komp Max} is predetermined as follows:

$$k \cdot {S}_{x} {=}^{!} {S}_{Min} {=}^{!} k \cdot {S}_{Max} \qquad ( 5 )$$

Here, the proportionality factor k·Sₓ is determined either directly with the aid of the minimum value MIN (=S_{Min}, with k=1), or indirectly via a proportional relation to the maximum value MAX (=S_{Max}).

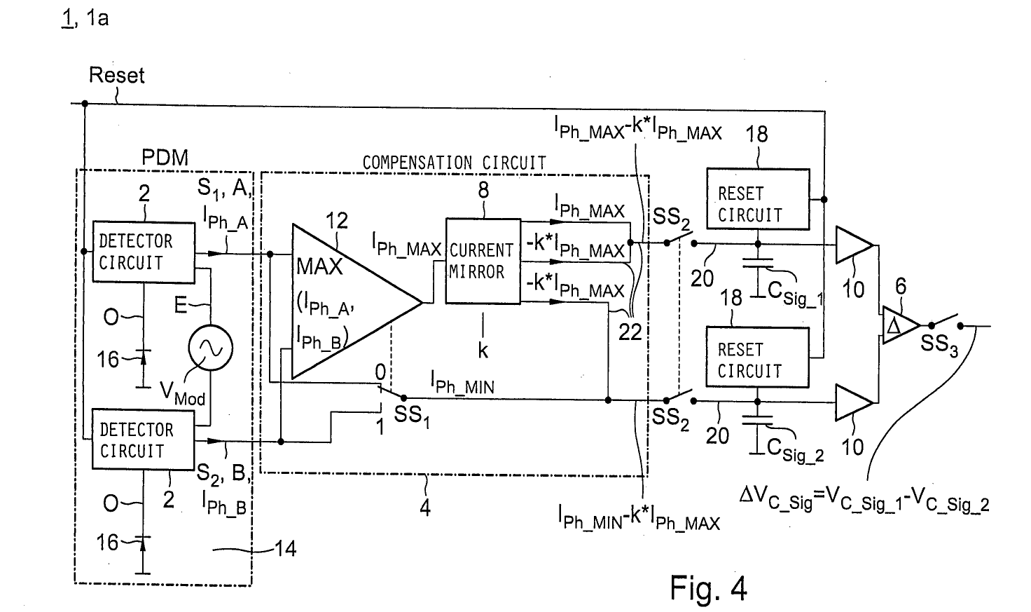

Particularly advantageous is the application of the described constant component compensation in a photodetector arrangement 1 of a special two-channel system with photodetector units 2, embodied as so-called Photonic mixer detectors 14 (also called Photonic Mixer Devices, in short “PMD”), as is shown in FIG. 4. Photonic Mixer Detectors 14 are used as components for mixing electrical signals E and optical signals O. They consist of at least two photodetector units 2 arranged in pairs, onto which load carriers, which are generated in the semi-conductor by an active scene illumination, are distributed in a certain pattern when being mixed with an electrical signal E. Here, a photo element 16 for detecting the optical signal O is related to the respective photodetector unit 14.

For instance, photonic mixer detectors 14 are used to produce 3D image information. For this purpose exclusively the differences are analyzed of the measuring signals S₁ (=I_{Ph}_{_{—}}_{A}) and S₂ (=I_{Ph}_{_{—}}_{B}) detected and determined in the photodetector units 3 arranged in pairs.

The essential aspect, which argues in favor of an application, is the fact that apart from the potential, unknown constant components S_{GL}, which e.g. are caused by stray light, the generated measuring signals S₁ and S₂ always contain a known constant component S_{mGL} caused by principle and thus being measurable and determinable. This determinable constant component S_{mGL} is given for instance by the mean maximum modulation contrast MK_{Max} as per:

$${\overline{MK}}_{Max} = \frac{\overline{\vert {( Δ S )}_{Max} \vert}}{Σ S \vert \text{?} \vert} \\ \text{?} \text{indicates text missing or illegible when filed} \qquad ( 6 )$$

Here, the mean maximum modulation contrast MK_{Max} is determined for instance by the variation of parameters specific by production and layout, as for example semi-conductor material and component geometries, and, therefore, can be determined experimentally after production and can be considered to be constant. The relation between the mean maximum modulation contrast MK_{Max} and the minimum, relative constant component S_{GL} of the signals S₁ and S₂ is predetermined by the following:

$$\frac{{S}_{{GL}_{Min}}}{MAX ( {S}_{1} , {S}_{2} )} = \frac{1 - {\overline{MK}}_{Max}}{1 + {\overline{MK}}_{Max}} \qquad ( 7 )$$

By way of this the relation to the amplification factor k of the proportionality factor k·Sₓ according to the photodetector arrangement 1 in FIG. 2 can be adjusted as follows:

$${k}_{Max} = \frac{1 - {\overline{MK}}_{Max}}{1 + {\overline{MK}}_{Max}} \qquad ( 8 )$$

The photodetector arrangement 1 shown in FIG. 4 with photonic mixer detectors 14, compensation unit 4 and differential unit 6, can be produced in a particularly simple form of embodiment as an integrated circuit for example of semi-conductor components, wherein all elements can be arranged directly at the photo element 16 and at the photonic mixer detector 14 on the semi-conductor. A photodetector arrangement 1 of this type thus represents a form of embodiment for an active pixel sensor 1a (also called Active Pixel Sensor, in short APS).

When operating the photodetector arrangement 1 the electrical signal E is generated by means of a signal source V_{Mod}, which signal E is mixed in the photonic mixer detector 14 with the optical signal O received respectively by both photodetector units 2. The result of the mixture is provided simultaneously in form of the two measuring signals S₁ and S₂ as so-called photo currents I_{Ph A} and I_{Ph B}, resp., via relating signal paths A and B, resp.

Basically, all signal forms are suitable for the conversion of the optical signal O with the electrical signal E into the electrical measuring signal S₁ and S₂, resp. (e.g. rectangular, sinus, triangular, pseudo noise, pulse group forms, etc.). Preferably, with the method as described here, caused by the integrated embodiment temporal mean values of the respective signal form are produced.

For initializing the photodetector arrangement 1, it is set by means of a reset circuit 18 relating to the respective measuring signal S₁ and S₂, resp., with the aid of a reset impulse into a defined starting or initial state. An integration capacity C_{Sig 1} and C_{Sig 2} is associated to the respective reset circuit 18. During initialization the integration capacities C_{Sig 1} and C_{Sig 2} are loaded to a defined voltage level by means of the respectively associated reset circuit 18, on the other hand initializing of the two photo elements 16 is performed via the photodetector units 2 arranged in the photonic mixer detector 14.

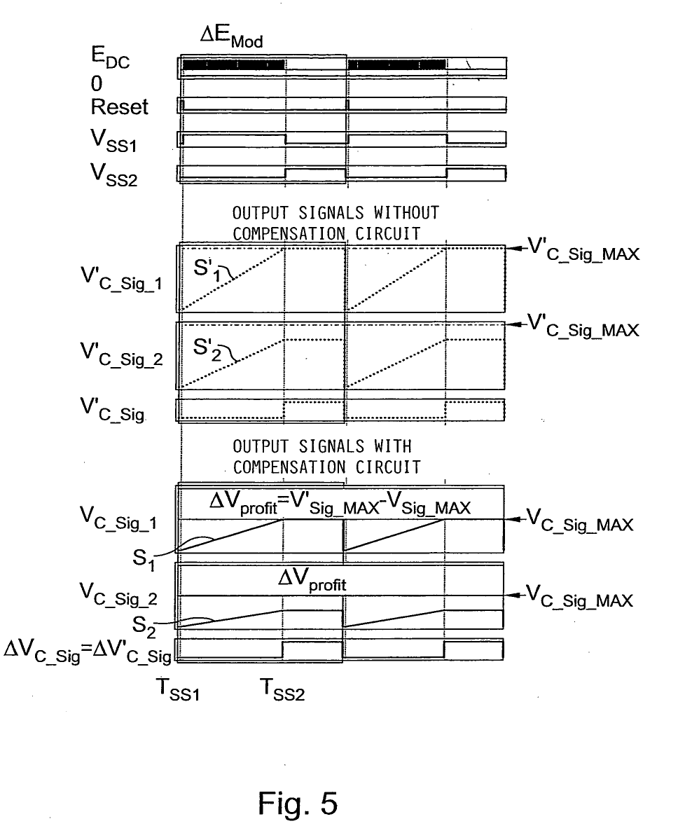

The functionality of the photodetector arrangement 1 according to FIG. 4 is supplemented by the time diagram shown in FIG. 5 and is further explained below. FIG. 5 shows the time diagram for activating the photodetector arrangement 1 for constant component compensation. For clarifying the mode of operation it contains the representations of the output signal courses without and with the constant component compensation circuit.

At the time T_{SS1} an active scenery illumination ΔE_{MOD} is switched on while simultaneously closing the switch SS₁. The resulting electrical signals E and the optical signals O are converted by means of the two photodetector units 2, arranged in pairs, of the photonic mixer detector 14 into the photo currents I_{Ph A} and I_{Ph B}, representing the measuring signals S₁ and S₂, on the signal paths A and B. The total photocurrent or the respective measuring signal S₁ and S₂, resp., is composed of the active scenery illumination ΔE_{MOD} forming the wanted signal portion S_{1/2Δ} and a stray light E_{DC} of the scenery forming the disturbance afflicted constant component S_{GL}.

The signal integration at the integration capacities C_{Sig 1} and C_{Sig 2} is performed without a compensation circuit pursuant to the signal courses V′_{C Sig 1} and V′_{C Sig 2} and with compensation circuit pursuant to the signal courses V_{C Sig 1} and V_{C Sig 2}, as far as to the time T_{SS2}, until which the switch SS₁ is opened and switch SS₂ is closed. The prerequisite for this is that the integration capacities C_{Sig 1} and C_{Sig 2} are at no time in the region of saturation and thus one can start from an approximate linear integration. As far as to the anew reset impulse the signal courses V′_{C Sig 1} and V′_{C Sig 2} without compensation and the signal courses V_{C Sig 1} and V_{C Sig 2} with compensation, resp., are accordingly held at the integration capacities C_{Sig 1} and C_{Sig 2}.

In this context, at the switch SS₂ the compensated measuring signal S₁ and S₂, resp., formed via the appropriate amplifier unit 8 and the subtracter or differential module 10 is applied to one of the two selection lines as a difference signal ΔC_{Sig}.

The comparison of the measuring signals S′₁ and S′₂ of the signal courses V′_{C Sig 1} and V′_{C Sig 2} (without compensation circuit) with the measuring signals S₁ and S₂ of the signal courses V_{C Sig 1} and V_{C Sig 2} (with compensation circuit) shows that the constant component compensation G_{Komp} the voltage level at the integration capacities C_{Sig 1} and C_{Sig 2}, used for subtraction, are reduced without affecting the differential signal ΔV_{C Sig} (=ΔV′_{C Sig}). The reduction of the voltage level discloses the possibility to integrate additional, optically generated load carriers onto the capacities C_{Sig 1} and C_{Sig 2}. Hereby an additional useable part of the existing dynamic region is created, what amounts to an increase of the dynamic range. The absolute value of this increase is determined by the potential difference V_{profit} and results as per FIG. 5 from the difference of the signals V′_{C Sig Max} and V_{C Sig Max}.
ΔV_{profit}=V′_{C}_{_{—}}_{Sig}_{_{—}}_{Max}−V_{C}_{_{—}}_{Sig}_{_{—}}_{Max} (9)

The key function of the compensation circuit is the reduction of the constant component S_{GL} of the photo currents I_{Ph A} and I_{Ph B} representing the measuring signals S₁ and S₂ before they are integrated onto the capacities C_{Sig 1} and C_{Sig 2}.

The photodetector arrangement 1 shown in FIG. 4 comprises for this purpose the amplifier unit 8 embodied as a so-called current mirror. On the basis of the photo current I_{Ph A} (I_{Ph B} is analogue to this) a so-called photo current circuit of the amplifier unit 8 generates accordingly compensated currents k·I_{ph A} and I_{Ph A}, resp., by impressing the amplification factor k. They assist in generating in a very simple manner the differential signals ΔI_{Ph}=I_{Ph A}−k·I_{Ph A} and ΔI_{Ph}=I_{Ph B}−k·I_{Ph A} resp., by bringing together the corresponding output lines 22. The amplification factor k can be adjusted, for example, via the width/length ratio (W/L) of the CMOS-transistors of the used current mirror or via corresponding bias currents. The advantage of this circuit arrangement and of the method resulting of it caused by its simplicity is the low implementation expenditure, further improvements, however, can be done with the non-constant degree of compensation, as already described above.

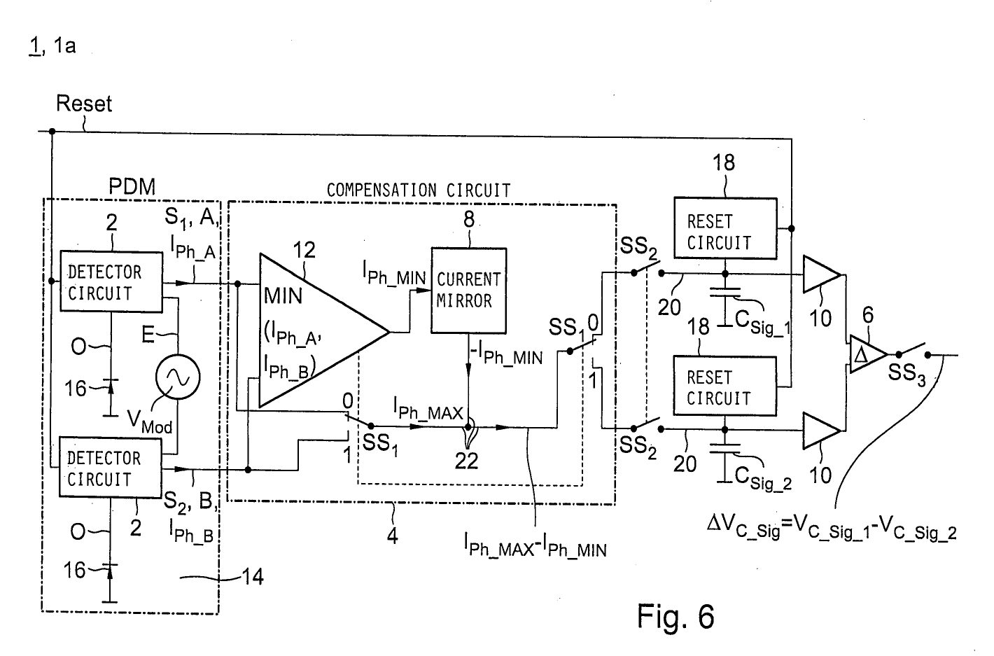

FIG. 6 shows an alternative form of embodiment for a photodetector arrangement 1, by means of which, irrespective of the sign of the differential signal ΔIₚₕ=I_{Ph A}−I_{Ph B}, a maximum degree of compensation G_{Komp} of 100% can be achieved for the constant component S_{GL}.

In comparison to the photodetector arrangement 1 shown in FIG. 4, in this case the limit value module 12 is integrated with two coupled three-way switches SS1 as detection of the minimum value MIN. The design of the current mirror circuit by means of the amplifier unit 8, however, is less complex.

The smaller of the two photo currents I_{Ph A} and I_{Ph B} provides the maximum constant component S_{GL}=I_{Ph MIN} which is irrelevant with regard to the subtraction. For this reason it is necessary to determine the minimum photo current I_{Ph MIN} directly after the reset phase, in which the integration capacities C_{Sig 1} and C_{Sig 2} and the photo elements 16 are initialized.

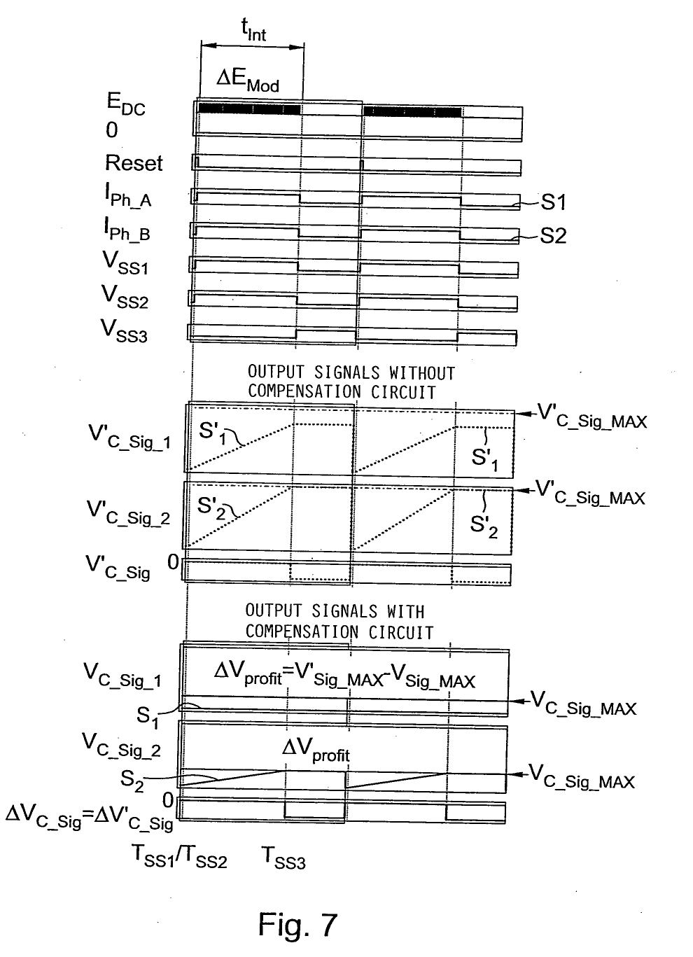

The time diagram shown in FIG. 7 for the photodetector arrangement 1 for constant component compensation G_{Komp} while taking into account a maximum constant component compensation G_{Komp MAX} as per FIG. 6 shows exemplarily the signal courses V′_{C Sig 1} and V′_{C Sig 2} as well as V_{C Sig 1} and V_{C Sig 2} for the case I_{Ph A}<I_{Ph B}.

At the time T_{SS1} in this case at the start of the active scenery illumination ΔE_{MOD} the switch SS₁ switches into the state “1” and SS₂ is closed. The minimum value MIN identified by the limit value module 12 of the applied photo currents I_{Ph}_{_{—}}_{A} and I_{Ph}_{_{—}}_{B}, i.e. current I_{Ph}_{_{—}}_{MIN} (e.g. photo current I_{Ph A}) learns by the current mirror arrangement of the amplifier unit 8 a reversion of signs and is brought together by means of output lines 22 with the current I_{Ph MAX} (e.g. photo current I_{Ph B}) for subtraction. For maintaining the correct sign with the ensuing subtraction, integration is performed via the switches SS₁ and SS₂ onto the capacity C_{Sig 2}. The potential at the integration capacity C_{Sig 1} is kept unchanged. At the time T_{SS3} the integration is terminated and the differential signal ΔC_{Sig} is led via switch SS₃ to the selection line 20 until the anew reset impulse.

The comparison of the signal courses V′_{C Sig 1} and V′_{C Sig 2} (without compensation circuit) with the signal courses V_{C Sig 1} and V_{C Sig 2} (with compensation circuit) shows to what extent the voltage levels at the capacities C_{Sig 1} and C_{Sig 2} are reduced by the compensation arrangement or compensation unit 4, without affecting hereby the initial differential signal. The potential difference ΔV_{profit} delivers the compensation part, i.e. the additional useable part of the dynamic range.

It must be noted at this place, that the photodetector arrangement 1 shown in FIG. 6 may alternatively also be equipped with a limit value module 12 embodied as a maximum detector. In this case a current mirror arrangement according to the amplifier unit in FIG. 4 would be used. An arrangement of this type, when compared with the amplifier unit 8 shown in FIG. 6, would not compensate the entire constant component of the photo currents I_{Ph A} and I_{Ph B}, however, when compared with the compensation circuit of FIG. 4 an improvement of the performance based on the constant degree of compensation would entail.

The various photodetector arrangements 1 producing a constant component compensation described here have a significantly higher dynamic range in contrast to conventional arrangements, which results in a considerable enhancement of the performance of such components in technical applications.

The method can be used for an individual photodetector unit 2 as well as for a line or an array arrangement of detectors 2.

In a line arrangement the proposed photodetector arrangements 1 can be applied as image recording devices in line cameras. Furthermore, line arrangements are possible as optical multi-channel systems for separating different modulation channels. The activation and signal selection of the individual pixels of such line arrangement is usually performed with multiplexer components.

The same applies for a two-dimensional matrix arrangement, as they are used in planar sensors for video cameras. Multiplexer components are used here for activating and selecting the detector elements each for the lines and the columns of the matrix arrangement.

The subject invention has been presented by way of the above description, such that the principle of the invention and its practical application can be explained best possible, however, the invention can, of course, be realized in divers other forms of embodiment when being modified appropriately.

### LIST OF REFERENCE NUMERALS

1 Photodetector arrangement
2 Photodetector unit
4 Compensation unit
6 Differential unit
8 Amplifier unit
10 Differential module
12 Limit value module
14 Photonic mixer detectors
16 Photo element
18 Reset switch
20 Selection line
22 Output line
“1” State
A, B Signal paths
C_{Sig 1}, C_{Sig 2} Integration capacity
E Electrical signals
E_{DC} Stray light
G_{Komp} Constant component compensation
G_{Komp MAX} Maximum degree of compensation
I_{Ph A}, I_{Ph B} Photo currents
I_{Ph MAX} Maximum photo current
I_{Ph MIN} Minimum photo current
k Amplification factor
k I_{Ph A}, I_{Ph B} Currents
K Sₓ Proportionality factor
MAX Maximum value
MIN Minimum value
MK_{Max} Modulation contrast
O Optical signals
S₁, S₂ Measuring signals with compensation
S′₁, S′₂ Measuring signals without compensation
S_{1Δ}, and S_{2Δ} Portions of wanted signal
S₁>S₂ Maximum value
S₁<S₂ Minimum value
S_{GL} Constant components
S_{mGL} Measurable constant components
S_{MIN}, S_{MAX} Signals
SS₁, SS₂ Switches
Sₓ Signals
T_{SS1}, T_{SS2}, T_{SS3} Times
V_{C Sig 1}, V_{C Sig 2} Signal courses with compensation
V′_{C Sig 1}, V′_{C Sig 2} Signal courses without compensation
V_{C Sig Max}/V′_{C Sig Max} Signal course for the maximum value with/without compensation
V_{Mod} Signal source
W/L Width-length-ratio
ΔC_{Sig} Differential signal
ΔE_{MOD} Scenery illumination
ΔI_{Ph}=I_{Ph A}−k I_{Ph A},
ΔI_{Ph}=I_{Ph B}−k I_{Ph A} Differential signals
ΔS Differential signal
ΔV_{profit} Potential differences
ΔV_{C Sig}, ΔV′_{C Sig} Differential signals

1. A photodetector arrangement (1) for stray light compensation with a photodetector unit (2) for detecting and determining at least two measuring signals (S₁ and S₂) and with a differential unit (6) for subtraction of the measuring signals (S₁ and S₂), wherein between the photodetector unit (2) and the differential unit (6) a compensation unit (4) is provided for compensating the constant components (S_{GL}, S_{mGL}) forming the basis of the respective measuring signal (S₁ and S₂).

2. A photodetector arrangement according to claim 1, wherein the compensation unit (4) comprises a number of differential modules (10) which corresponds to the number of measuring signals (S₁ and S₂).

3-8. (canceled)

9. A method for stray light compensation of measuring signals (S₁, S₂) detected by means of a photodetector unit (2), wherein a constant component (S_{GL}, S_{mGL}) forming the basis of the respective measuring signal (S₁, S₂) is compensated before subtraction of the measuring signals (S₁, S₂).

10. A method according to claim 9, wherein for the measuring signals (S₁, S₂) a constant component (S_{GL}, S_{mGL}) is determined, which commonly represents these signals.

11-13. (canceled)

14. A photodetector arrangement according to claim 1, wherein the compensation unit (4) comprises an amplifier unit (8).

15. A photodetector arrangement according to claim 14, wherein an amplifier unit (8) common for all measuring signals (S₁ and S₂) is provided.

16. A photodetector arrangement according to claim 14, wherein a number of amplifier units (8) is provided, which corresponds to the number of the detected measuring signals (S₁ and S₂).

17. A photodetector arrangement according to claim 1, wherein the compensation unit (4) comprises a limit value module (12).

18. A photodetector arrangement according to claim 1, wherein photodetector unit (2) is embodied as a photonic mixer detector (14).

19. A photodetector arrangement according to claim 1, wherein the photodetector unit (2) is embodied as an active pixel sensor.

20. A method according to claim 9, wherein for the constant component (S_{GL}, S_{mGL}) at least one constant factor is determined.

21. A method according to claim 9, wherein the constant component (S_{GL}, S_{mGL}) is determined as a function of one of the measuring signals (S₁, S₂).

22. A method according to claim 9, wherein the constant component (S_{GL}, S_{mGL}) is determined at least by means of a mean maximum modulation contrast.
